(19) United States
(12) Patent Application Publication
(10) Pub. No.: US 2014/0120752 A1
(43) Pub. Date: May 1, 2014

(54) ELECTRONIC DEVICE

(71) Applicants: INVENTEC (PUDONG) TECHNOLOGY CORPORATION, (US); INVENTEC CORPORATION, Taipei (TW)

(72) Inventor: Lung-Pai Cheng, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/779,234

(22) Filed: Feb. 27, 2013

(30) Foreign Application Priority Data
Oct. 29, 2012 (CN) 201210421436.9

(51) Int. Cl. H01R 13/447

(52) U.S. Cl. CPC H01R 13/447
USPC 439/136

(57) ABSTRACT

An electronic device includes a case, a connection port and a cover. The case has an opening and at least a first slide rail. The first slide rail is disposed on a lateral wall of the opening. The connection port is disposed inside the case and the opening exposes the connection port. The cover is slidably disposed on the first slide rail. When the cover is at a first position, the cover covers the opening at least partially. When the cover slides along the first slide rail to a second position, the cover exposes the opening and a connector can be inserted into the connection port.

### CROSS-REFERENCE TO RELATED APPLICATIONS

This non-provisional application claims priority under 35 U.S.C. §119(a) on Patent Application No(s). 201210421436.9 filed in China, P.R.C. on Oct. 29, 2012, the entire contents of which are hereby incorporated by reference.

### BACKGROUND OF THE INVENTION

1. Technical Field of the Invention

The disclosure relates to an electronic device, more particularly to an electronic device having a connection port.

2. Description of the Related Art

In the rapid development of technology, portable electronic devices such as tablet computers and notebook computers are widely used by users because of the advantages of portability and a simple operational design. Notebook computers are mostly equipped with a network connection port for connecting a cable connector such as the RJ45 connector.

The network connection port of a notebook computer is usually exposed on a lateral side of the notebook computer. Thus, it is unable to achieve simplicity in the notebook computer design. Furthermore, the thickness of the notebook computer case must be larger than that of the connection port in order to wrap around the connection port completely. In order words, the thickness of the lateral side of the notebook computer must be larger than the standard thickness of the connection port, so the connection port is able to be disposed in the notebook computer. Therefore, the design of an existing connection port affects the look of a notebook computer and is detrimental to the concept of the slim design of a notebook computer.

### SUMMARY OF THE INVENTION

In an embodiment, the disclosure provides an electronic device comprising a case, a connection port and a cover. The case has an opening and at least a first slide rail. The first slide rail is disposed on a lateral wall of the opening. The connection port is disposed inside the case and the opening exposes the connection port. The cover is slidably disposed on the first slide rail. When the cover is at a first position, the cover covers the opening at least partially. When the cover slides along the first slide rail to a second position, the cover exposes the opening and a connector is configured for being inserted into the connection port.

### BRIEF DESCRIPTION OF THE DRAWINGS

The disclosure will become more fully understood from the detailed description given herein below for illustration only and thus does not limit the disclosure, wherein:

FIG. 1 is a partial perspective view of an electronic device according to an embodiment of the disclosure;

FIG. 2 is a perspective view of a cover exposing an opening in FIG. 1;

FIG. 3 is a partial sectional view of the electronic device in FIG. 2;

FIG. 4 is a view from V1 side of the electronic device in FIG. 3;

FIG. 5 is a partial side view of the electronic device according to another embodiment of the disclosure;

FIG. 6 is a sectional view along the line I-I in FIG. 5; and

FIG. 7 is a perspective view of partial components of the electronic device in FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

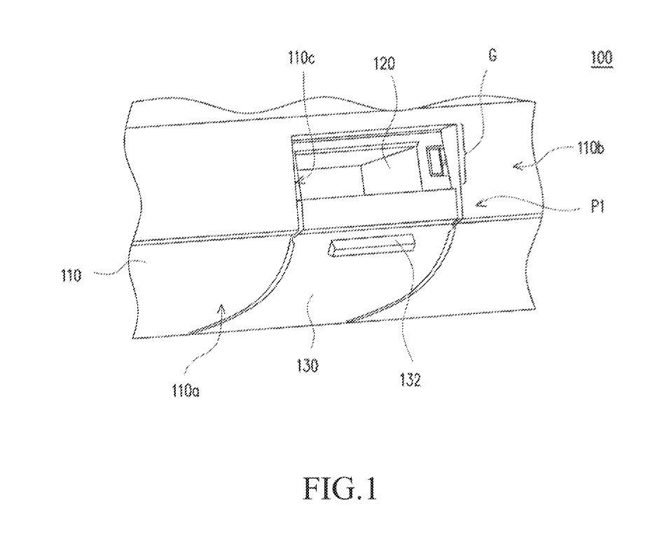

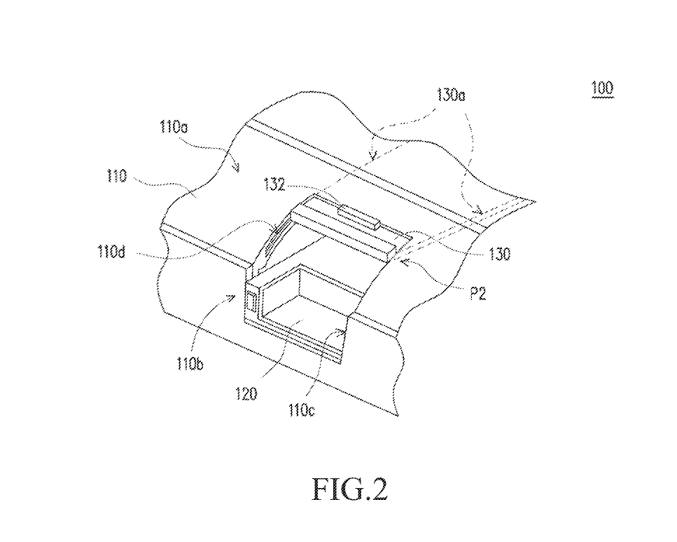

FIG. 1 is a partial perspective view of an electronic device according to an embodiment of the disclosure. FIG. 2 is a perspective view of a cover exposing an opening in FIG. 1. In order to illustrate the drawings more explicitly, FIG. 1 and FIG. 2 are drawn based on different view angles (a bottom side 110a of a case 110 in FIG. 1 faces downward, and the bottom side 110a of the case 110 in FIG. 2 faces upward). Please refer to FIGS. 1 and 2. In this and some other embodiments, an electronic device 100 of this embodiment is a notebook computer. The electronic device 100 comprises the case 110, a connection port 120 and a cover 130. The case 110 has the bottom side 110a, a lateral side 110b, an opening 110c and at least a first slide rail 110d. The opening 110c extends from the lateral side 110b of the case 110 to the bottom side 110a of the case 110. The first slide rail 110d is disposed on a lateral wall of the opening 110c. The connection port 120 is disposed inside the case 110 and the opening 110c exposes the connection port 120. The cover 130 is slidably disposed on the first slide rail 110d.

As shown in FIG. 1, when the cover 130 is at a first position P1, the cover 130 covers the opening 110c at least partially. When the cover 130 slides along the first slide rail 110d to a second position P2 as shown in FIG. 2, the cover 130 exposes the opening 110c and a connector (not shown) is configured for being inserted into the connection port 120 from the lateral side 110b. The connector is, for example, a RJ45 connector, and the connection port 120 is, for example, a RJ45 connection port. However, it should not be construed as a limitation to the disclosure. In other embodiments, the connector and the connection port 120 are other applicable connectors or connection ports.

According to the above dispositions, the cover 130 is disposed at the opening 110c of the case 110 of the electronic device 100. The cover 130 is configured for sliding along the first slide rail 110d in order to cover or expose the opening 110c at least partially. Thereby, when a user needs to use the connection port 120, the cover 130 is able to be made to expose the opening 110c in order so the connector can be inserted into the connection port 120 through the opening 110c. When the user does not need to use the connection port 120, the cover 130 is configured for covering the opening 110c in order to shield the connection port 120, exposed by the opening 110c, and to make an outer appearance of the electronic device 100 look more esthetically appealing. Furthermore, since the opening 110c extends from the lateral side 110b of the case 110 to the bottom side 110a of the case 110, at the bottom side 110a of the electronic device 100, the connection port 120 is covered by the cover 130 instead of the case 110. Because the connection port 120 is not covered by the bottom side 110a of the case 110, an overall thickness of the case 110 is able to be reduced in order to meet the trend of light and slim electronic devices.

In this embodiment, the cover 130 is a flexible structure. The flexibility of the cover 130 enables the cover 130 to move smoothly along an extending direction of the first slide rail 110d between the statuses shown in FIGS. 1 and 2. Specifically, when the cover 130 is at the first position P1 as shown in FIG. 1, the cover 130 is in a curved shape and extends from the bottom side 110a to the lateral side 110b in order to cover the opening 110c at least partially. When the cover 130 is at the second position P2 as shown in FIG. 2, the shape the cover 130 is configured for being changed into a flat shape by its flexibility and disposed on the bottom side 110a. In this and some other embodiments, the cover 130 is a thin acrylic board with flexibility. In other embodiments, the cover 130 may be made of other applicable flexible materials. Nonetheless, it should not be construed as a limitation of the disclosure.

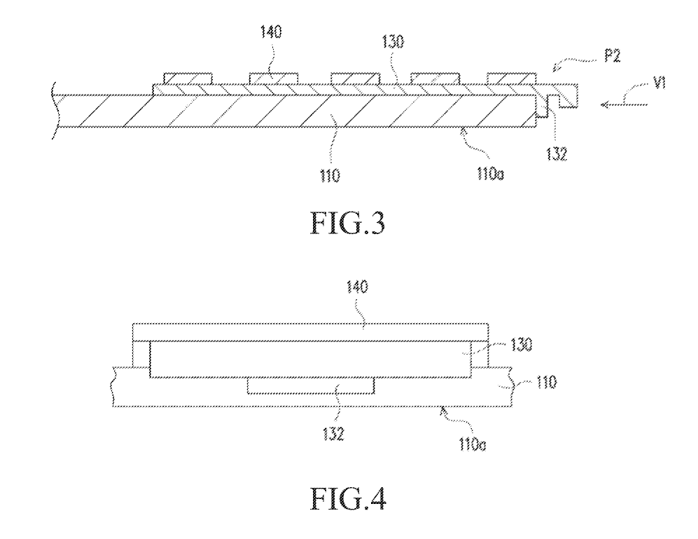

FIG. 3 is a partial sectional view of the electronic device in FIG. 2. FIG. 4 is a view from V1 side of the electronic device in FIG. 3. Please refer to FIGS. 3 and 4. In this embodiment, the electronic device 100 (as shown in FIG. 2) further comprises a plurality of limitation structures 140 disposed inside the case 110. The limitation structures 140 are arranged in a direction parallel to the bottom side 110a. When the cover 130 is at the second position P2, the cover 130 is disposed between the limitation structures 140 and the case 110, and the shape of the cover 130 is limited by the limitation structures 140 to change into a flat shape due to its flexibility, as shown in FIG. 3.

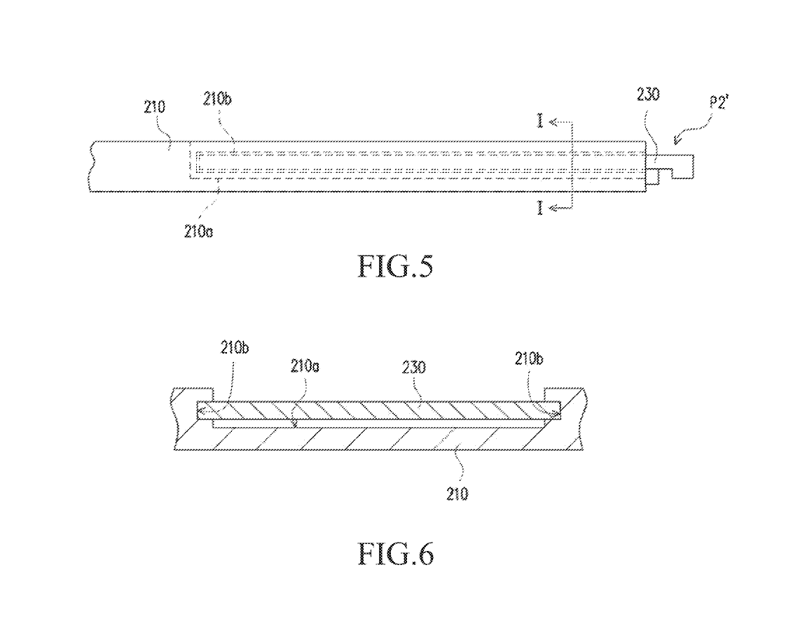

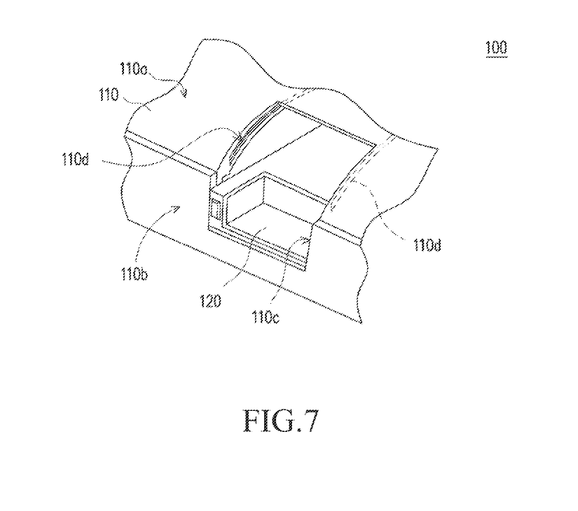

FIG. 5 is a partial side view of the electronic device according to another embodiment of the disclosure. FIG. 6 is a sectional view along the line I-I in FIG. 5. In the embodiment shown in FIG. 5 and FIG. 6, the cover is limited to be in a flat shape in a way different from the way illustrated in FIGS. 3 and 4, and is described in detail as follows. Please refer to FIGS. 5 and 6. A concavity 210a and a second slide rail 210b (two of the second slide rails 210b are shown in FIG. 6) are disposed inside a case 210 of this embodiment. The second slide rail 210b is disposed on an inner wall of the concavity 210a. When a cover 230 is at a second position P2′ (corresponding to the second position P2 shown in FIG. 2 and FIG. 3), the cover 230 is disposed on the second slide rail 210b, and the shape of the cover 230 is limited by the second slide rail 210b to change into a flat shape due to its flexibility, as shown in FIG. 5.

In the embodiment shown in FIG. 1, when the cover 130 is at the first position P1, the opening 110c is not completely covered by the cover 130, a part (the part indicated by G) of the opening 110c is exposed by the cover 130. When the connector is inserted into the exposed part (the part indicated by G) of the opening 110c and is moved towards the connection port 120, the cover 130 is pushed by the connector to the second position P2 as shown in FIG. 2 during the insertion of the connector, and the connector is inserted into the connection port 120. In other words, when the cover 130 is at the first position P1, the user can use the connector to push the cover 130 to the second position P2 and insert the connector into the connection port 120. Thereby, the connector is able to be inserted into connection port 120 more conveniently.

Please refer to FIGS. 2 to 4. The cover 130 has a protruded rib 132. When the cover 130 is at the second position P2, the protruded rib 132 is pressed against the case 110 in order to limit a sliding range of the cover 130 and to position the cover 130 at the second position P2.

FIG. 7 is a perspective view of the partial components of the electronic device in FIG. 2. In order to illustrate the drawing more explicitly, the cover 130 in FIG. 2 is not shown in FIG. 7. Please refer to FIG. 7. The quantity of the first slide rail 110d of the case 110 is, for example, two. Two opposite lateral sides 130a of the cover 130 (shown in FIG. 2) are slidably disposed on the two first slide rails 110d respectively in order so the cover 130 is configured for being slidably disposed at the opening 110c steadily.

As a conclusion, the cover is disposed at the opening of the case of the electronic device of the disclosure. The cover is configured for sliding along the first slide rail in order to cover or expose the opening at least partially. Thereby, when the user needs to use the connection port, the cover is configured for being made to expose the opening in order so the connector is able to be inserted into the connection port through the opening.

When the user does not need to use the connection port, the cover is configured for being made to cover the opening in order to shield the connection port exposed by the opening and to make an outer appearance of the electronic device to look more esthetically appealing. Furthermore, since the opening extends from the lateral side of the case to the bottom side of the case, at the bottom side of the electronic device, the connection port is covered by the cover instead of the case. Since the connection port is not covered by the bottom side of the case, an overall thickness of the case can be reduced in order to meet the trend of light and slim electronic devices.

What is claimed is:

1. An electronic device, comprising:
a case having an opening and at least a first slide rail, wherein the first slide rail is disposed on a lateral wall of the opening;
a connection port disposed inside the case, and the opening exposing the connection port; and
a cover slidably disposed on the first slide rail, wherein when the cover is at a first position, the cover covers the opening at least partially, when the cover slides along the first slide rail to a second position, the cover exposes the opening and a connector is configured for being inserted into the connection port.

2. The electronic device as claimed in claim 1, wherein the case has a bottom side and a lateral side, the opening extends from the lateral side to the bottom side, the connector is inserted into the connection port from the lateral side.

3. The electronic device as claimed in claim 2, wherein the cover is a flexible structure, when the cover is at the first position, the cover is in a curved shape and extends from the bottom side to the lateral side, when the cover is at the second position, the cover is in a flat shape and is disposed on the bottom side.

4. The electronic device as claimed in claim 3, further comprising a plurality of limitation structures disposed inside the case, wherein the limitation structures are arranged in a direction parallel to the bottom side, when the cover is at the second position, the cover is disposed between the limitation structures and the case, and the limitation structures limit the shape of the cover to a flat shape.

5. The electronic device as claimed in claim 3, wherein a concavity and a second slide rail are disposed inside the case, the second slide rail is disposed on an inner wall of the concavity, when the cover is at the second position, the cover is disposed on the second slide rail, and the second slide rail limits the shape of the cover to a flat shape.

6. The electronic device as claimed in claim 1, wherein when the cover is at the first position, a part of the opening is exposed by the cover and when the connector is inserted into a exposed part of the opening and moved towards the connection port, the cover is pushed to the second position by the connector, and the connector is inserted into the connection port.

7. The electronic device as claimed in claim 1, wherein the quantity of the at least one first slide rail is two, two opposite lateral sides of the cover are slidably disposed on the two first slide rails respectively.

8. The electronic device as claimed in claim 1, wherein the cover has a protruded rib, and when the cover is at the second position, the protruded rib is pressed against the case for limiting a sliding range of the cover.

9. The electronic device as claimed in claim 1, wherein the connection port is a RJ45 connection port, and the connector is a RJ45 connector.
